(19) United States
(12) Patent Application Publication
(10) Pub. No.: US 2015/0015230 A1
(43) Pub. Date: Jan. 15, 2015

(54) ELECTRONIC DEVICE AND SWITCHING CIRCUIT CAPABLE OF SWITCHING BETWEEN POWER-SAVING MODE AND NORMAL MODE

(71) Applicants: HON HAI PRECISION INDUSTRY CO., LTD., New Taipei (TW); HONG FU JIN PRECISION INDUSTRY (SheZhen) Co., LTD., Shenzhen (CN)

(72) Inventor: TAO WANG, Shenzhen (CN)

(73) Assignees: HON HAI PRECISION INDUSTRY CO., LTD., New Taipei (TW); HONG FU JIN PRECISION INDUSTRY (SheZhen) Co., LTD., Shenzhen (CN)

(21) Appl. No.: 13/968,416

(22) Filed: Aug. 15, 2013

(30) Foreign Application Priority Data
Jul. 10, 2013 (CN) 2013102880251

(51) Int. Cl. H02M 11/00

(52) U.S. Cl. CPC H02M 11/00
USPC 323/318

(57) ABSTRACT

An electronic device includes a power-saving mode and a normal mode. When a mechanical button is in a first position, a main control chip outputs a logic high pulse to a switch connected to a voltage converter, such that the switch is turned on, and the voltage converter is disabled. The electronic device accordingly enters the power-saving mode because power from an external power source cannot be converted to a work voltage of the electronic device via the voltage converter. When the mechanical button is in a second position, the main control chip outputs a logic low pulse to the switch, such that the switch is turned on, and the voltage converter is enabled. The electronic device accordingly enters the normal mode because power from the external power source can be converted to the work voltage of the electronic device via the voltage converter.

### BACKGROUND

1. Technical Field

The present disclosure relates to electronic devices, and particularly, to an electronic device automatically switching between a power-saving mode and a normal mode and a related switching circuit.

2. Description of Related Art

A mechanical button can be used to switch some electronic devices between a power saving mode and a normal mode. FIG. 2 shows that such an electronic device 100 includes a power source interface 10, a voltage converter 11, main control chip 12, a voltage control chip 13, and a mechanical button 14. The power source interface 10 is connected to an external power source. The voltage converter 11 converts the power from the external power source to a work voltage of the electronic device 100. When the voltage at an enable pin of the voltage converter 11 is logic high, the voltage converter 11 works. When the voltage at an enable pin of the voltage converter 11 is logic low, the voltage converter 11 is disabled. The mechanical button 14 includes a first terminal 141, a second terminal 142, a third terminal 143, and a conductive operable portion 144. The first terminal 141 is connected to a power source VCC, the second terminal 142 is connected to a pin of the voltage control chip 13, and the third terminal 143 is grounded. When the mechanical button 14 is in a first position, the first terminal 141 and the second terminal 142 are connected to each other via the operable portion 144. When the mechanical button 14 is in a second position, the second terminal 142 and the third terminal 143 are connected to each other via the operable portion 144. Another pin of the voltage control chip 13 is connected to the enable pin of the voltage converter 11. When the mechanical button 14 is in the first position, the voltage control chip 13 detects that the voltage at the second terminal 142 is logic high, and then the voltage control chip 13 sets the voltage at the enable pin to be logic high, thus the voltage converter 11 works, and the electronic device 100 enters a normal mode. When the mechanical button 14 is in the second position, the voltage control chip 13 detects that the voltage at the second terminal 142 is logic low, and then the voltage control chip 13 sets the voltage at the enable pin to be logic low, thus the voltage converter 11 is disabled, the main control chip 12 is disabled, and the electronic device 100 enters a power-saving mode. The above-mentioned method for switching the electronic device 100 between the normal mode and the power-saving mode depends on the voltage control chip 13, which may increase the cost of the electronic device 100.

### BRIEF DESCRIPTION OF THE DRAWINGS

Many aspects of the present disclosure should be better understood with reference to the following drawings. The units in the drawings are not necessarily drawn to scale, the emphasis instead being placed upon clearly illustrating the principles of the present disclosure. Moreover, in the drawings, like reference numerals designate corresponding portions throughout the several views.

FIG. 1 is a block diagram of an electronic device capable of switching between a power-saving mode and a normal mode, in accordance with an exemplary embodiment.

FIG. 2 is a block diagram of a known electronic device capable of switching between a power-saving mode and a normal mode.

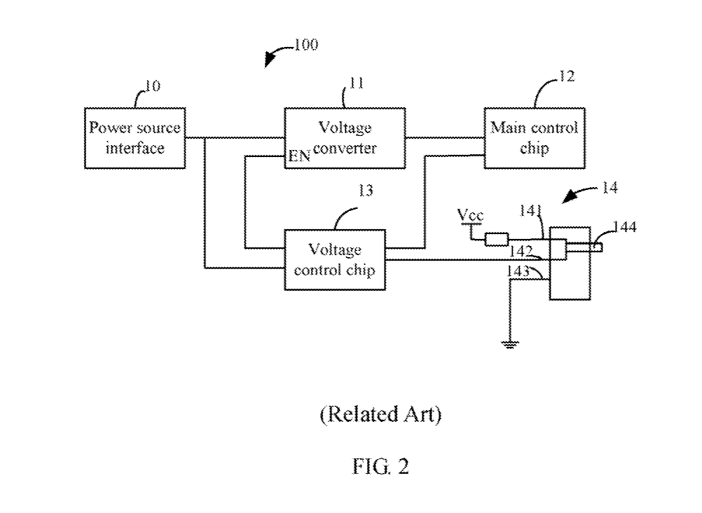

### DETAILED DESCRIPTION

Embodiments of the present disclosure are described, with reference to the accompanying drawings.

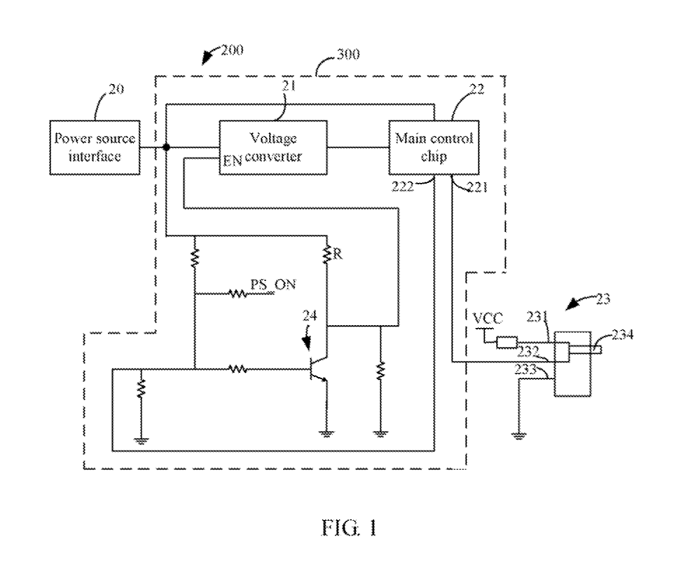

FIG. 1 is an embodiment of an electronic device 200. The electronic device 200 includes a power source interface 20, a switching circuit 300, and a mechanical button 23. The switching circuit 300 includes a voltage converter 21 and a main control chip 22. The power source interface 20 is connected to an external power source. The voltage converter 21 converts the power from the external power source to a work voltage of the electronic device 200. When the voltage at an enable pin of the voltage converter 21 is logic high, the voltage converter 21 works. When the voltage at the enable pin is logic low, the voltage converter 21 is disabled. The mechanical button 23 includes a first terminal 231, a second terminal 232, a third terminal 233, and a conductive operable portion 234. The first terminal 231 is connected to a power source VCC, the second terminal is connected to a detection pin 221 of the main control chip 22, and the third terminal 233 is grounded. When the mechanical button 23 is in a first position, the first terminal 231 and the second terminal 232 are connected to each other via the operable portion 234. When the mechanical button 23 is in a second position, the first terminal 232 and the third terminal 233 are connected to each other via the operable portion 234. The main control chip 22 is further connected to the power source interface 20.

In this embodiment, the electronic device 200 further includes a resistor R1 and a switch 24. The power source interface 20 is connected to the enable pin of the voltage converter 21 via the resistor R1. The enable pin is further grounded via the switch 24. An I/O pin 222 of the main control chip 22 is connected to an end of the switch 24. When the mechanical button 23 is in the second position, the voltage at the detection pin 221 is logic low, the main control chip 22 outputs a logic high pulse to the switch 24 via the I/O pin 222, such that the switch 24 is turned on. At this point, the enable pin is grounded, such that the voltage converter 21 is disabled, thus the electronic device 200 enters a power-saving mode. In the power-saving mode, the main control chip 22 can also receive power from the external power source, thus the main control chip 22 can still detect the state of the mechanical button 23. When the mechanical button 23 is moved to the first position, the voltage at the detection pin 221 is logic high, the main control chip 22 outputs a logic low pulse to the switch 24 via the I/O pin, thus the switch 24 is turned off. At this point, the enable pin of the voltage converter 21 is connected to the power source interface 20 via the resistor R1, such that the voltage at the enable pin is logic high, and the voltage converter 21 works. Thus, the electronic device 200 switches from the power-saving mode to a normal mode. In this embodiment, the switch 24 is a transistor. The base of the transistor is connected to the I/O pin 222, the emitter is grounded, and the collector is connected to the resistor R1 and the enable pin.

With such configuration, by the resistor R1 and the switch 24, the electronic device 200 can be switched between the power-saving mode and the normal mode. Thus, the cost is decreased.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. An electronic device capable of switching between a power-saving mode and a normal mode, comprising:
a power source interface to connect the electronic device to an external power source;
a voltage converter to convert power from the external power source to a work voltage of the electronic device, wherein, the voltage converter comprises an enable pin, when the voltage at the enable pin is logic high, the voltage converter works;
a mechanical button comprising a first terminal, a second terminal, a third terminal, and a conductive operable portion, wherein, the first terminal is connected to a power source VCC, the third terminal is grounded, when the mechanical button is in a first position, the first terminal and the second terminal are connected to each other via the operable portion, and when the mechanical button is in a second position, the second terminal and the third terminal are connected to each other via the operable portion;
a main control chip connected to the voltage converter and the power source interface, and comprising a detection pin and an I/O pin, wherein, the detection pin is connected to the second terminal of the mechanical button;
a resistor; and
a switch;
wherein, the enable pin of the voltage converter is connected to the power source interface via the resistor, and further grounded via the switch, the I/O pin of the main control chip is connected to an end of the switch, when the voltage at the detection pin of the main control chip is logic high, the main control chip outputs a logic high pulse to the switch via the I/O pin, such that the switch is turned on, and the voltage at the enable pin goes to be logic low, when the voltage at the detection pin is logic high, the main control chip outputs a logic low pulse to the switch via the I/O pin, such that the switch is turned off, and the voltage at the enable pin goes to be logic low.

2. The electronic device as described in claim 1, wherein the switch is a transistor, the base of the transistor is connected to the I/O pin of the main control chip, the emitter is grounded, and the collector is connected to the resistor and the enable pin.

3. A switching circuit applied in an electronic device, the electronic device comprising a power source interface and a mechanical button, the power source interface being to connect the electronic device to an external power source, the mechanical button comprising a first terminal, a second terminal, a third terminal, and a conductive operable portion, the first terminal being connected to a power source VCC, the third terminal is grounded, when the mechanical button is in a first position, the first terminal and the second terminal are connected to each other via the operable portion, and when the mechanical button is in a second position, the second terminal and the third terminal are connected to each other via the operable portion, the switching circuit comprising:
a voltage converter to convert power from the external power source to a work voltage of the electronic device, wherein, the voltage converter comprises an enable pin, when the voltage at the enable pin is logic high, the voltage converter works;
a main control chip connected to the voltage converter and the power source interface, and comprising a detection pin and an I/O pin, wherein, the detection pin is connected to the second terminal of the mechanical button;
a resistor; and
a switch;
wherein, the enable pin of the voltage converter is connected to the power source interface via the resistor, and further grounded via the switch, the I/O pin of the main control chip is connected to an end of the switch, when the voltage at the detection pin of the main control chip is logic high, the main control chip outputs a logic high pulse to the switch via the I/O pin, such that the switch is turned on, and the voltage at the enable pin goes to be logic low, when the voltage at the detection pin is logic high, the main control chip outputs a logic low pulse to the switch via the I/O pin, such that the switch is turned off, and the voltage at the enable pin goes to be logic low.

4. The switching circuit as described in claim 3, wherein the switch is a transistor, the base of the transistor is connected to the I/O pin of the main control chip, the emitter is grounded, and the collector is connected to the resistor and the enable pin.
